(19) United States
(12) Patent Application Publication
(10) Pub. No.: US 2023/0214577 A1
(43) Pub. Date: Jul. 6, 2023

(54) CHARACTER STRING TRANSMISSION METHOD AND DEVICE, COMPUTER, AND READABLE STORAGE MEDIUM

(71) Applicant: INSPUR SUZHOU INTELLIGENT TECHNOLOGY CO., LTD., Suzhou, Jiangsu (CN)

(72) Inventor: Yigang ZHANG, Suzhou, Jiangsu (CN)

(21) Appl. No.: 17/916,832

(22) PCT Filed: Jan. 26, 2021
(86) PCT No.: PCT/CN2021/073700

§ 371 Date: Oct. 4, 2022

(30) Foreign Application Priority Data
Apr. 10, 2020 (CN) 202010279076.8

(51) Int. Cl. G06F 40/126; G06F 16/17

(52) U.S. Cl. CPC G06F 40/126; G06F 16/17

(57) ABSTRACT

Disclosed are a character string transmission method and device, a computer, and a readable storage medium. The method includes the following steps: obtaining a target character string, and adding an escape character before each special character in the target character string, the special character being a character that is incapable of being transmitted accurately to a target script; converting the special character into a transcoded character in an American Standard Code for Information Interchange (ASCII) code form to obtain a transcoded character string; transmitting the transcoded character string to the target script by means of a shell; and calling the target script to decode the transcoded character string to obtain the target character string. Compared with existing complex escape, the method is easier to implement, and the special character may be effectively prevented from being specially processed by the shell.

This application claims priority to Chinese Patent Application No. 202010279076.8, filed on Apr. 10, 2020, in China National Intellectual Property Administration and entitled “Character String Transmission Method and Device, Computer, and Readable Storage Medium”, the contents of which are hereby incorporated by reference in its entirety.

### FIELD

The present disclosure relates to the field of computer software technology, and particularly to a character string transmission method and device, a computer, and a readable storage medium.

### BACKGROUND

Program design of Linux (an operating system) often involves calling of a script in a program, and in most cases, parameters transmitted by the program to the script are relatively simple. However, in some cases, such as a case that a password with many special characters needs to be written to a file, transmission of special characters is involved. If a character string with special characters is directly transmitted to the script as a parameter in a Linux environment, a shell (shell of the computer operating system) may specially process some special characters in advance. For example, “$$” may be used as a Process Identification (PID) (a process identification number in the operating system, i.e., a process identifier) of a process. That is, if the parameter character string includes “$$”, the script may receive a numeric character string representing the PID of the process. As a result, the script receives a wrong parameter, further leading to an execution error.

In such case, these character strings with special characters need to be processed. A relatively classical method is to escape the special character with an escape character “\”. For example, the escape character may be added to escape $$ to “\S\S”. When there are relatively few special characters, this method is feasible. However, when there are many special characters, or there are many parameters with special characters, it is cumbersome to add the escape character to them one by one. Moreover, in some cases, the script, after obtaining these character strings, needs to write them to the file, and then the special characters need to be escaped in two layers, one of which is for parameter transmission between the program and the script while the other is for parameter transmission between the script and the file. An excessive number of escape layers makes an escape process cumbersome and increases the error rate.

In summary, how to effectively solve problems about the transmission of special characters, etc., is a technical problem urgent to be solved by those skilled in the art currently.

### SUMMARY

An objective of the present disclosure is to provide a character string transmission method and device, a computer, and a readable storage medium, so as to transmit special characters accurately to a target script when a Linux program calls the target script.

In order to solve the foregoing technical problem, the present disclosure provides the following technical solutions.

A character string transmission method is provided, including:

obtaining a target character string and adding an escape character before each special character in the target character string, the special character being a character that is incapable of being transmitted accurately to a target script;

converting the special character into a transcoded character in an American Standard Code for Information Interchange (ASCII) code form to obtain a transcoded character string;

transmitting the transcoded character string to the target script by means of a shell; and

calling the target script to decode the transcoded character string to obtain the target character string.

In some embodiments, the step of converting the special character into the transcoded character in the ASCII code form to obtain the transcoded character string includes:

converting the special character into an x+ASCII code form to obtain the transcoded character string.

In some embodiments, the step of converting the special character into the x+ASCII code form to obtain the transcoded character string includes:

converting the special character into the x+ASCII code form by use of a character string formatting command to obtain the transcoded character string.

In some embodiments, the step of calling the target script to decode the transcoded character string to obtain the target character string includes:

replacing each x in the transcoded character string with \\x; and

decoding and replacing the transcoded character in the transcoded character string by use of a character string display command to obtain the target character string.

In some embodiments, the step of obtaining the target character string includes:

determining whether a character string to be transmitted includes the special character; and

in response to the character string to be transmitted including the special character, determining the character string to be transmitted as the target character string.

In some embodiments, after the step of calling the target script to decode the transcoded character string to obtain the target character string, the method further includes:

modifying a target file by use of the target character string.

In some embodiments, the step of modifying the target file by use of the target character string includes:

calling a file write tool to modify the target file by use of the target character string.

A character string transmission device is provided, including:

a Linux program, configured to obtain a target character string, add an escape character before each special character in the target character string, the special character being a character that is incapable of being transmitted accurately to a target script, convert the special character into a transcoded character in an ASCII code form to obtain a transcoded character string, and transmit the transcoded character string to the target script by means of a shell; and

the target script, configured to accept a call of the Linux program to decode the transcoded character string to obtain the target character string.

A computer is provided, including:

a memory, configured to store a computer program; and

a processor, configured to execute the computer program to implement the steps of the character string transmission method as described above.

A readable storage medium is provided, storing a computer program that is executed by a processor to implement the steps of the character string transmission method as described above.

With adoption of the method provided in embodiments of the present disclosure, a target character string is obtained, and an escape character is added before each special character in the target character string, the special character being a character that is incapable of being transmitted accurately to a target script. The special character is converted into a transcoded character in an ASCII code form to obtain a transcoded character string. The transcoded character string is transmitted to the target script by means of a shell. The target script is called to decode the transcoded character string to obtain the target character string.

In this method, when a character string to be transmitted to a target script includes special characters, an escape character is first added before each special character, and then the special character is converted into a transcoded character in an ASCII code form to obtain a transcoded character string. That is, the transcoded character string no longer includes the special characters, and may be transmitted smoothly to the target script by means of a shell. Then, when the target script is called, the target script decodes the transcoded character string to obtain the target character string. That is, the target character string is escaped and transcoded, before being transmitted, to obtain the transcoded character string that may be transmitted to the target script, and after the transcoded character string is transmitted, the target script is called to decode the transcoded character string to obtain the target character string. As such, the special characters that originally may not be transmitted accurately to the target script may be transmitted accurately to the target script. Compared with existing complex escape, the method is easier to implement, and the special character may be effectively prevented from being specially processed by the shell.

Correspondingly, the embodiments of the present disclosure also provide a character string transmission device corresponding to the character string transmission method, a computer, and a readable storage medium, which have the foregoing technical effects. Elaborations are omitted herein.

### BRIEF DESCRIPTION OF THE DRAWINGS

In order to describe the technical solutions in the embodiments of the present disclosure or the prior art more clearly, the drawings required to be used in descriptions about the embodiments or the prior art will be introduced briefly below. Apparently, the drawings in the description below are only some embodiments of the present disclosure. Those ordinarily skilled in the art may further obtain other drawings according to these drawings without creative work.

FIG. 1 is an implementation flowchart of a character string transmission method according to an embodiment of the present disclosure;

FIG. 2 is a schematic structural diagram of a character string transmission device according to an embodiment of the present disclosure;

FIG. 3 is a schematic structural diagram of a computer according to an embodiment of the present disclosure;

FIG. 4 is a specific schematic structural diagram of a computer according to an embodiment of the present disclosure; and

FIG. 5 is a schematic diagram of a readable storage medium according to an embodiment of the present disclosure.

### DETAILED DESCRIPTION

In order to make the solutions of the present disclosure understood better by those skilled in the art, the present disclosure will be further described below in detail in combination with the drawings and specific implementation modes. Clearly, the described embodiments are not all but only part of embodiments of the present disclosure. All other embodiments obtained by those ordinarily skilled in the art based on the embodiments in the present disclosure without creative work shall fall within the scope of protection of the present disclosure.

### Embodiment 1

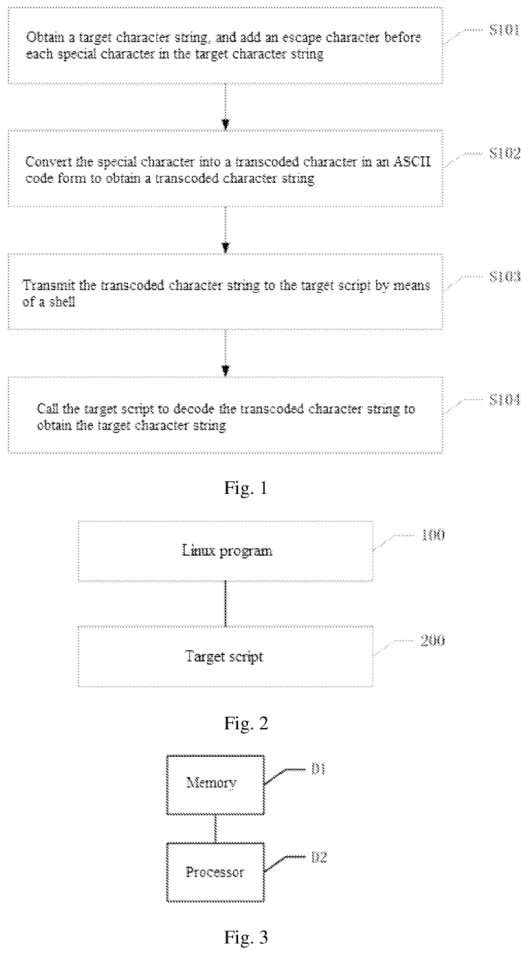

Referring to FIG. 1, FIG. 1 is a flowchart of a character string transmission method according to an embodiment of the present disclosure. The method is applicable to a computer installed with a Linux system. Steps of the method are implemented by a program in the computer. The method includes the following steps.

In S101, a target character string is obtained, and an escape character is added before each special character in the target character string.

The special character is a character that is incapable of being transmitted accurately to a target script. For example, the special character may include, but not limited to, “$$”, “<”, “>”, “;”, “′”, “″”, “\grave{ }”, “|”, “!”, “(”, and “&”. “$$” may be specially processed by a shell as a PID of a process, and then the script may receive a numeric character string representing the PID of the process. That is, the script receives a wrong parameter, further leading to an execution error. The Linux system mistakes “<” and “>” for output guide characters, so the Linux system does not transmit “<” and “>”, and reports error “file not found”. The Linux system may regard the character “;” as a command end mark and execute a content after the character “;” as a command. The Linux system may regard an unpaired single quote “′”, double quote “″”, and backtick “\grave{ }” as representing that data is not completely output, so the system keeps waiting for input. The Linux system may regard “|” as a piping symbol and execute a content after the character “|” as a command. The Linux system may regard the character “!” as logic “NOT” and report error “event not found”. The Linux system may regard the character “(” as a command group and report a syntax error. The Linux system may regard “&” as a background execution instruction and thus not transmit “&” and a content after “&”. Combining these special characters may even obtain unexpected results.

The target script is a script that needs to receive the target character string. The script itself may be a file modification file, or another script.

In the present embodiment, a character that may not be transmitted accurately to the target script may be stored in advance, so as to compare a character string to be transmitted to the script to determine whether an escape process is needed. That is, the step that a target character string is obtained includes the following steps.

In step 1, whether a character string to be transmitted includes the special character is determined.

In step 2, if YES, the character string to be transmitted is determined as the target character string.

The character string to be transmitted may be a character string to be transmitted to the target script, such as a password or configuration information input by a user.

Whether the character string to be transmitted includes the special character may be determined by traversing the character string to be transmitted. If including the special character, the character string to be transmitted is determined as the target character string. If not including the special character, the character string to be transmitted may be directly transmitted to the target script.

After the target character string is obtained, the special character in the target character string may be labeled for escaping. An escape character, i.e., “/”, may be added before each special character. For example, if the target character string includes a special character “>”, an escape character is added to obtain “/>”. If the target character string is “12eD>”, a transcoded character string obtained by adding the escape character is “12eD/>”. Certainly, in practical applications, the number and types of the special characters may be multiple, and enumerations are omitted herein.

In S102, the special character is converted into a transcoded character in an ASCII code form to obtain a transcoded character string.

ASCII, a set of Latin-alphabet-based computer coding system, is a universal standard for information interchange.

In the present embodiment, the special character added with the escape character is converted into a transcoded character in an ASCII code form to obtain a transcoded character string. That is, the transcoded character string includes no special character but the transcoded character of the ASCII code form corresponding to the special character. Using an ASCII code format may not only solve the problem of special character but also enable the target script to decode the received transcoded character string rapidly.

After the transcoded character string is transmitted to the target script, the target script further needs to be called to decode it. In consideration of this, to improve the decoding efficiency, the special character may also be converted into an x+ASCII code form in the present embodiment. That is, the special character may be converted into the x+ASCII code form to obtain the transcoded character string. There are many manners for converting the special character into the x+ASCII code form. Further, in order to improve the conversion efficiency, the special character may be converted into the x+ASCII code form by use of a character string formatting command to obtain the transcoded character string. That is, the target character string is traversed to find the special character added with the escape character, and each special character is converted into the x+ASCII code form. A hexadecimal format output may be specified by a sprintf( ) function (i.e., character string formatting command), so as to achieve a transcoding effect rapidly. Herein, x is mainly for facilitating hexadecimal escaping of an ASCII character by the script, so as to decode an ASCII code. By this step, a new character string including the character x and ASCII codes may be finally formed, whose form is xhhxhhxhhxhh . . . , where hh is a hexadecimal ASCII numeral.

After the special character in the target character string is transcoded, the transcoded character string may be obtained.

In S103, the transcoded character string is transmitted to the target script by means of a shell.

Since the transcoded character string no long includes the special character, the shell may not specially process the special character. For example, the character in the transcoded character string is no longer changed.

In S104, the target script is called to decode the transcoded character string to obtain the target character string.

The decoding process corresponds to transcoding and escaping. That is, the transcoded character is decoded to obtain the special character, and the transcoded character in the transcoded character string is replaced with the special character based on the special character to obtain the target character string. If the transcoded character in the transcoded character string is in the ASCII code form, the transcoded character in the ASCII code form is directly decoded to obtain the special character.

If the transcoded character in the transcoded character string is in the x+ASCII code form, a specific implementation process of decoding may include the following steps.

In step 1, each x in the transcoded character string is replaced with \\x.

In step 2, the transcoded character in the transcoded character string is decoded and replaced by use of a character string display command to obtain the target character string.

That is, after receiving the transcoded character string, the target script needs to decode the ASCII character string by two steps. In the first step, each “x” in the character string may be replaced with “\\x” by use of a Stream Editor (sed) command, where the first “\” is for escaping the second “\”, and “\x” combined from the second “\” and “x” represents a hexadecimal escape character. In the second step, the ASCII character may be decoded by use of an echo-e command (i.e., character string display command), and the main principle is that option -e may specially process the special character “\x”, so as to achieve the hexadecimal escape effect of “\x”. By this step, the ASCII numeral has been converted into a character in an ordinary format, namely recovered to the special character.

With adoption of the method provided in the embodiment of the present disclosure, a target character string is obtained, and an escape character is added before each special character in the target character string, the special character being a character that is incapable of being transmitted accurately to a target script. The special character is converted into a transcoded character in an ASCII code form to obtain a transcoded character string. The transcoded character string is transmitted to the target script by means of a shell. The target script is called to decode the transcoded character string to obtain the target character string.

In this method, when a character string to be transmitted to a target script includes special characters, an escape character is first added before each special character, and then the special character is converted into a transcoded character in an ASCII code form to obtain a transcoded character string. That is, the transcoded character string no longer includes the special characters, and may be transmitted smoothly to the target script by means of a shell. Then, when the target script is called, the target script decodes the transcoded character string to obtain the target character string. That is, the target character string is escaped and transcoded, before being transmitted, to obtain the transcoded character string that may be transmitted to the target script, and after the transcoded character string is transmitted, the target script is called to decode the transcoded character string to obtain the target character string. As such, the special characters that originally may not be transmitted accurately to the target script may be transmitted accurately to the target script. Compared with existing complex escape, the method is easier to implement, and the special character may be effectively prevented from being specially processed by the shell.

It is to be noted that, based on the above-mentioned embodiment, the embodiments of the present disclosure also provide a corresponding improved solution. References may be made between the same steps or corresponding steps in the improved embodiment and embodiment 1 and between corresponding beneficial effects. Elaborations are omitted in the improved embodiment herein.

After step S104 is performed, the target script obtains the target character string, and then may modify a target file directly by use of the target character string. A file write tool may be called to modify the target file by use of the target character string.

After the transcoded character in the transcoded character string is escaped into an ordinary character, a file write operation may be performed. For example, a common file write tool may be used, such as awk (a text processing tool) and sed. When these tools are used for file modification operations, some special characters in received character string parameters may also be processed. For example, “\” may be processed as an escape character, so “\n” may be regarded as “n” first, and “\” does not work as a space. However, the special character has been escaped in step S101 by a character string escaping operation. That is, “\n” in the character string has been processed into “\\n” in the first step. Therefore, there is no error even if the target character string obtained by step S104 is processed by use of awk or sed.

### Embodiment 2

Corresponding to the above method embodiment, the embodiment of the present disclosure also provides a character string transmission device. Corresponding references may be made between the character string transmission device described below and the character string transmission method described above.

As shown in FIG. 2, the device includes the following modules:

a Linux program 100, configured to obtain a target character string, add an escape character before each special character in the target character string, the special character being a character that is incapable of being transmitted accurately to a target script, convert the special character into a transcoded character in an ASCII code form to obtain a transcoded character string, and transmit the transcoded character string to the target script by means of a shell; and

the target script 200, configured to accept a call of the Linux program to decode the transcoded character string to obtain the target character string.

With adoption of the device provided in the embodiment of the present disclosure, a target character string is obtained, and an escape character is added before each special character in the target character string, the special character being a character that is incapable of being transmitted accurately to a target script. The special character is converted into a transcoded character in an ASCII code form to obtain a transcoded character string. The transcoded character string is transmitted to the target script by means of a shell. The target script is called to decode the transcoded character string to obtain the target character string.

In this device, when a character string to be transmitted to a target script includes special characters, an escape character is first added before each special character, and then the special character is converted into a transcoded character in an ASCII code form to obtain a transcoded character string. That is, the transcoded character string no longer includes the special characters, and may be transmitted smoothly to the target script by means of a shell. Then, when the target script is called, the target script decodes the transcoded character string to obtain the target character string. That is, the target character string is escaped and transcoded, before being transmitted, to obtain the transcoded character string that may be transmitted to the target script, and after the transcoded character string is transmitted, the target script is called to decode the transcoded character string to obtain the target character string. As such, the special characters that originally may not be transmitted accurately to the target script may be transmitted accurately to the target script. Compared with existing complex escape, the device is easier to implement, and the special character may be effectively prevented from being specially processed by the shell.

In a specific implementation mode of the present disclosure, the Linux program 100 is configured to convert the special character into an x+ASCII code form to obtain the transcoded character string.

In a specific implementation mode of the present disclosure, the Linux program 100 is configured to convert the special character into the x+ASCII code form by use of a character string formatting command to obtain the transcoded character string.

In a specific implementation mode of the present disclosure, the target script 200 is configured to replace each x in the transcoded character string with \\x, and decode and replace the transcoded character in the transcoded character string by use of a character string display command to obtain the target character string.

In a specific implementation mode of the present disclosure, the Linux program 100 is configured to determine whether a character string to be transmitted includes the special character, and if YES, determine the character string to be transmitted as the target character string.

In a specific implementation mode of the present disclosure, the target script 200 is configured to modify a target file by use of the target character string after the target script is called to decode the transcoded character string to obtain the target character string.

In a specific implementation mode of the present disclosure, the target script 200 is configured to call a file write tool to modify the target file by use of the target character string.

### Embodiment 3

Corresponding to the above method embodiment, the embodiment of the present disclosure also provides a computer. Corresponding references may be made between the computer described below and the character string transmission method described above.

As shown in FIG. 3, the computer includes:

a memory D1, configured to store a computer program; and

a processor D2, configured to execute the computer program to implement the steps of the character string transmission method of the method embodiment.

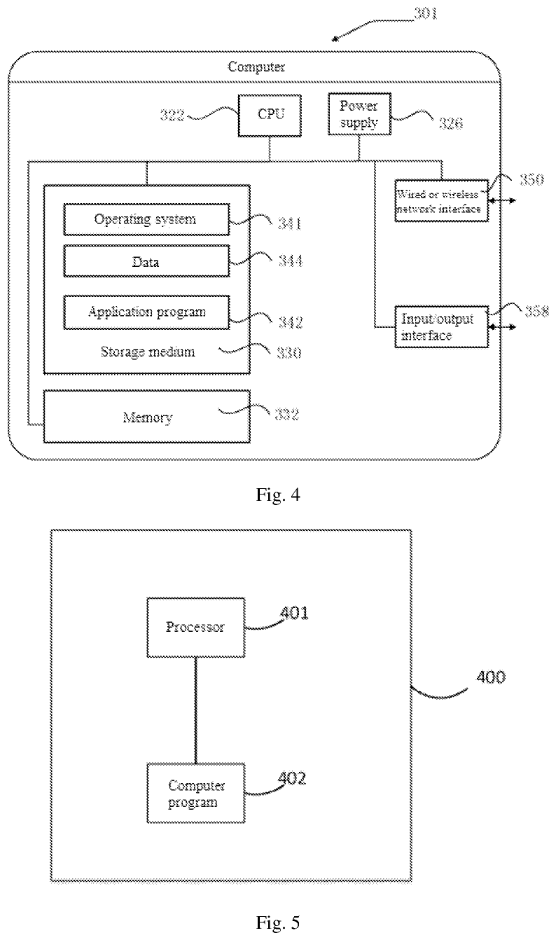

Referring to FIG. 4, a specific schematic structural diagram of the computer provided in this embodiment is shown. The computer may differ greatly in case of different configurations or performance. It may include one or more Central Processing Units (CPUs) (322) (such as one or more processors) and memories 332, and one or more storage media 330 (such as one or more mass storage devices) that store application programs 342 or data 344. The memory 332 and the storage medium 330 may implement temporary storage or persistent storage. The program stored in the storage medium 330 may include one or more modules (not shown in the figure), each of which may include a series of instruction operations on a data processing device. Furthermore, the CPU 322 may be configured to communicate with the storage medium 330 to execute, on the computer 301, a series of instruction operations in the storage medium 330.

The computer 301 may further include one or more power supplies 326, one or more wired or wireless network interfaces 350, one or more input/output interfaces 358, and/or, at least one Linux operating system 341.

The steps in the character string transmission method described above may be implemented by the structure of the computer 301.

### Embodiment 4

Corresponding to the above method embodiment, the embodiment of the present disclosure also provides a readable storage medium 400. Corresponding references may be made between the readable storage medium 400 described below and the character string transmission method described above.

FIG. 5 shows a readable storage medium 400. The readable storage medium 400 stores a computer program 402. The computer program 402 is executed by a processor 401 to implement the steps of the character string transmission method of the method embodiment.

The readable storage medium may be various readable storage media capable of storing program codes, such as a U disk (a mobile memory (flash) using a Universal Serial Bus (USB) transmission protocol), a mobile hard disk, a Read-Only Memory (ROM), a Random Access Memory (RAM), a magnetic disk, or an optical disk.

Professionals may further realize that the units and algorithm steps of each example described in combination with the embodiments disclosed herein may be implemented by electronic hardware, computer software, or a combination thereof. For clarity of description about the interchangeability of hardware and software, the compositions and steps of each example have been described generally in the foregoing descriptions according to functions. Whether these functions are executed by hardware or software depends on specific applications and design constraints of the technical solutions. Professionals may realize the described functions for each specific application by use of different methods, but such realization shall fall within the scope of the present disclosure.

1. A character string transmission method, comprising:
obtaining a target character string, and adding an escape character before each special character in the target character string, wherein the special character is a character that is incapable of being transmitted accurately to a target script;
converting the special character into a transcoded character in an American Standard Code for Information Interchange (ASCII) code form to obtain a transcoded character string;
transmitting the transcoded character string to the target script by means of a shell; and
calling the target script to decode the transcoded character string to obtain the target character string.

2. The character string transmission method according to claim 1, wherein the step of converting the special character into the transcoded character in the ASCII code form to obtain the transcoded character string comprises:
converting the special character into an x+ASCII code form to obtain the transcoded character string.

3. The character string transmission method according to claim 2, wherein the step of converting the special character into the x+ASCII code form to obtain the transcoded character string comprises:
converting the special character into the x+ASCII code form by use of a character string formatting command to obtain the transcoded character string.

4. The character string transmission method according to claim 3, wherein the step of calling the target script to decode the transcoded character string to obtain the target character string comprises:
replacing each x in the transcoded character string with \\x; and
decoding and replacing the transcoded character in the transcoded character string by use of a character string display command to obtain the target character string.

5. The character string transmission method according to claim 1, wherein the step of obtaining the target character string comprises:
determining whether a character string to be transmitted comprises the special character; and
in response to the character string to be transmitted comprising the special character, determining the character string to be transmitted as the target character string.

6. The character string transmission method according to claim 1, wherein after the step of calling the target script to decode the transcoded character string to obtain the target character string, the method further comprises:
modifying a target file by use of the target character string.

7. The character string transmission method according to claim 6, wherein the step of modifying the target file by use of the target character string comprises:
calling a file write tool to modify the target file by use of the target character string.

8. (canceled)

9. A computer, comprising:
a memory, configured to store a computer program; and
a processor, configured to execute the computer program, and upon execution of the computer program, configured to:
obtain a target character string, and add an escape character before each special character in the target character string, wherein the special character is a character that is incapable of being transmitted accurately to a target script;
convert the special character into a transcoded character in an American Standard Code for Information Interchange (ASCII) code form to obtain a transcoded character string;
transmit the transcoded character string to the target script by means of a shell; and
call the target script to decode the transcoded character string to obtain the target character string.

10. A non-transitory computer-readable storage medium, storing a computer program that is executable by a processor, and upon execution by the processor, is configured to cause the processor to:
obtain a target character string, and add an escape character before each special character in the target character string, wherein the special character is a character that is incapable of being transmitted accurately to a target script;
convert the special character into a transcoded character in an American Standard Code for Information Interchange (ASCII) code form to obtain a transcoded character string;
transmit the transcoded character string to the target script by means of a shell; and
call the target script to decode the transcoded character string to obtain the target character string.

11. The computer according to claim 9, wherein the processor, upon execution of the computer program, is further configured to:
convert the special character into an x+ASCII code form to obtain the transcoded character string.

12. The computer according to claim 11, wherein the processor, upon execution of the computer program, is further configured to:
convert the special character into the x+ASCII code form by use of a character string formatting command to obtain the transcoded character string.

13. The computer according to claim 12, wherein the processor, upon execution of the computer program, is further configured to:
replace each x in the transcoded character string with \\x; and
decode and replace the transcoded character in the transcoded character string by use of a character string display command to obtain the target character string.

14. The computer according to claim 9, wherein the processor, upon execution of the computer program, is further configured to:
determine whether a character string to be transmitted comprises the special character; and
in response to the character string to be transmitted comprising the special character, determine the character string to be transmitted as the target character string.

15. The computer according to claim 9, wherein the processor, upon execution of the computer program, is further configured to:
modify a target file by use of the target character string.

16. The computer according to claim 15, wherein the processor, upon execution of the computer program, is further configured to:
call a file write tool to modify the target file by use of the target character string.

17. The non-transitory computer-readable storage medium according to claim 10, wherein the computer program, upon execution by the processor, is further configured to cause the processor to:
convert the special character into an x+ASCII code form to obtain the transcoded character string.

18. The non-transitory computer-readable storage medium according to claim 17, wherein the computer program, upon execution by the processor, is further configured to cause the processor to:
convert the special character into the x+ASCII code form by use of a character string formatting command to obtain the transcoded character string.

19. The non-transitory computer-readable storage medium according to claim 18, wherein the computer program, upon execution by the processor, is further configured to cause the processor to:
replace each x in the transcoded character string with \\x; and
decode and replace the transcoded character in the transcoded character string by use of a character string display command to obtain the target character string.

20. The non-transitory computer-readable storage medium according to claim 10, wherein the computer program, upon execution by the processor, is further configured to cause the processor to:
determine whether a character string to be transmitted comprises the special character; and
in response to the character string to be transmitted comprising the special character, determine the character string to be transmitted as the target character string.

21. The non-transitory computer-readable storage medium according to claim 10, wherein the computer program, upon execution by the processor, is further configured to cause the processor to:
modify a target file by use of the target character string.
